(19) United States
(12) Patent Application Publication
(10) Pub. No.: US 2024/0016260 A1
(43) Pub. Date: Jan. 18, 2024

(54) FASTENING DEVICE, METHOD OF PRODUCTION AND FASTENING SYSTEM THEREOF

(71) Applicant: Gottlieb Binder GmbH & Co. KG, Holzgerlingen (DE)

(72) Inventors: Konstantinos Poulakis, Hildrizhausen (DE); Lars Heepe, Tuebingen (DE)

(73) Assignee: Gottlieb Binder GmbH & Co. KG, Holzgerlingen (DE)

(21) Appl. No.: 18/358,309

(22) Filed: Jul. 25, 2023

Related U.S. Application Data
(63) Continuation of application No. PCT/EP2022/050043, filed on Jan. 4, 2022.

(30) Foreign Application Priority Data
Jan. 27, 2021 (DE) 102021000393.4

(51) Int. Cl. A44B 18/00; D06C 13/08; B60N 3/04

(52) U.S. Cl. CPC A44B 18/0061; D06C 13/08; A44B 18/0057; A44B 18/0034; A44B 18/0038; A44B 18/008; B60N 3/046; A44B 18/0092

(57) ABSTRACT

A fastening device has a plurality of individual spaced-apart interlocking elements made of a plastics material, each of which projects towards one side from a carrier part by being provided with a stem part and a head part. The number of interlocking elements is 100 to 200 pieces per cm², preferably 120 pieces per cm². The diameter of the stem part of an interlocking element is 150 to 250 μm, preferably 213 μm. The height of the interlocking element, calculated from the root-side base on the carrier part to the head-part end, is 1200 to 2200 μm, preferably 1500 to 1980 μm. The dimension of the largest head-part diameter of an interlocking element is 200 to 400 μm, preferably 220 to 290 μm.

### CROSS-REFERENCE TO RELATED APPLICATIONS

This continuation application claims priority to PCT/EP2022/050043 filed on Jan. 4, 2022, which has published as WO 2022/161744 A1 and also the German application number 10 2021 000 393.4 filed on Jan. 27, 2021, the entire contents of which are fully incorporated herein with these references.

### DESCRIPTION

### Field of the Invention

The invention relates to a fastening device, consisting of a plurality of individual spaced-apart interlocking elements made of a plastics material, each of which projects towards one side from a carrier part by being provided with a stem part and a head part.

### Background of the Invention

DE 10 2013 009 091 A1 discloses a method for producing a connecting part using an injection molding method, wherein in a first step a fastener part forming a component of a hook-and-loop fastener is produced with adhesive or interlocking elements and is introduced as an insert part into an injection mold in which, in a second step, the connecting part is formed by means of a back injection process in the form of a component that contains the fastener part as an integral part. The known connecting part produced according to this method has a base body, preferably in the form of a flat plate, which has on one side a fastener part forming a component of a hook-and-loop fastener with adhesive or interlocking elements and preferably on the other side an anchoring or other fixing device for fixing the base body to a structure, such as, for example, the partial region of a vehicle floor on which a floor mat is to be fixed.

A similar method for producing a connecting part using a foam injection molding method is the subject matter of EP 3 003 675 B1.

It has been shown that the known fastener parts or interlocking elements with associated fastening devices form high-strength system connections with one another, which can be separated from one another again if the actuating forces to be applied by hand are correspondingly high, in the sense of a re-detachable Kletten® hook-and-loop fastener, but also at any time in case of need. To obtain such a connecting solution, specially matched surfaces and individual components are required, which leads to correspondingly high production costs, which also applies in the case where the known fastening systems are produced by means of an injection molding method. If a plate-like hook-and-loop fastener part is produced as a fastening device in this way, it is relatively large when viewed in the axial direction, and the engagement option projecting from the actual hook-and-loop fastener plate, in the form of a web-like projecting latching part, is required in order to be able to fix the hook-and-loop fastener plate to third-party components, such as a vehicle floor.

### SUMMARY OF THE INVENTION

Based on this prior art, the invention is based on the object of creating a fastening device that is improved in comparison, is functionally reliable in operation with comparable adhesive forces, can be implemented cost-effectively and requires less installation space on site. A fastening device with the features of claim 1 achieves an object to this effect in its entirety.

In that, according to the characterizing part of claim 1: the number of interlocking elements is 100 to 200 pieces per cm², preferably 120 pieces per cm²; the diameter of the stem part of an interlocking element is 150 to 250, preferably 213 μm; the height of the interlocking element, calculated from the root-side base on the carrier part to the head-part end, is 1200 to 2200 μm, preferably 1500 to 1980 μm; and the dimension of the largest head-part diameter of an interlocking element is 200 to 400 μm, preferably 220 to 290 μm. Hair-like stem parts are created, which are also referred to in technical language as pole elements and which have a small cross-sectional widening in the manner of a thickening as a head part at their one, free end. It is surprising for a person skilled in the art in the field of such hook-and-loop fastener systems to achieve almost the same adhesive values for the fastening device with very long hair-like stem parts and a head-part diameter that is only slightly larger than the diameter of the stem part, preferably 2 to 5% larger, than with the known prior art solutions described above.

Since the long-dimensioned stem parts are flexible to a certain extent and in this respect are mounted on the carrier part in a yielding and articulated manner via their foot part, there are increased options for engagement, which likewise benefits the increase in adhesion. As the above geometric dimensions illustrate, each stem part is a linear element that integrally connects to the head part to form an interlocking element. Preferably, the head part is designed as a point-shaped sphere. In a particularly preferred manner, the interlocking elements are part of a base fabric made of warp and weft yarns.

In view of this, since the number of interlocking elements can be reduced, the fastening device can be obtained with a smaller input quantity of plastics material, which reduces production costs.

The fastening device can be used directly with its carrier part for adhesion processes on third-party components, such that complex and large plate solutions can be eliminated for the purpose of holding the hook-and-loop fastener part, which in turn helps to reduce production costs and increases the functional reliability for the fastening device.

With a preferred embodiment of the fastening device according to the invention, it is provided that the interlocking elements all have the same height as viewed from the carrier part and extend away from said carrier part in a vertically or obliquely inclined manner and/or that pairs of interlocking elements arranged adjacent to one another on the carrier part form a V-shape or X-shape with one another and/or that the stem parts are curved in an arc shape with the same or different orientation. In this way, the interlocking elements or the pole elements can be arranged in different isotropic or anisotropic arrangements on the carrier part, resulting in improved adhesion within the scope of a wide range of possible applications.

Due to the fact that in a preferred embodiment the arc-shaped curvature of a stem part is selected in such a way that a free head side, as viewed in perpendicular projection onto the carrier part, runs within an associated projection line that ends at the root side at a transition point between the stem part and the carrier part, improved adhesion is achieved and, due to the arc-shaped curvature, the inherent elasticity of the fastener system is improved.

Preferably, it is provided that the respective curvature, as viewed in the direction of the head part, is more curved than in the direction of the root-side end of the stem part.

For further improved adhesion, it can preferably be provided that the interlocking elements with their curved stem parts are inclined towards one another in pairs with their head parts, forming a kind of clamp-like receiving opening.

In a further preferred embodiment of the fastening device according to the invention, it is provided that the carrier part consists of a woven fabric, a warp-knit fabric or a weft-knit fabric with interlocking elements interwoven therein or of a 3D film. In this way, different anchoring options can be created for the interlocking or pole elements with the carrier part, which also increases the possible applications.

With a further preferred embodiment of the fastening device according to the invention, it is provided that a functional part is applied to the side of the carrier part that is rearward of the interlocking elements, preferably in the form of a self-adhesive layer or a reactivatable layer or in the form of an additional fastening part, such as a plastic profile or a plastic clip. The aforementioned different functional layers can be used to fasten the fastening device to third-party components. Thus, a self-adhesive layer can be realized by means of a rubber or acrylate adhesive, which is attached to the rear side of the carrier part in a planar manner. Reactivatable layers can be thermally bonded or welded under the influence of heat. The additional functional part can also consist of a fastening part, such as a plastic profile or a plastic clip, with which the fastening device can also be subsequently fixed to third-party components.

Here, it is preferably provided that the interlocking elements and/or the carrier part are made of polyester or polyamide, such as PA66, as plastics materials. Furthermore, it is possible to provide or coat such plastics materials with flame-retardant materials, such that the fastening device as a whole becomes flame-retardant.

The fastening device can be advantageously produced using various methods. With a method according to the invention, it is provided that the loops of a loop pile fabric having a carrier part are cut open to form stem parts, and the free loop ends are each scarfed to form the head part of an interlocking element. As a result, the interlocking elements are part of a woven fabric consisting of warp and weft threads and in this respect are securely anchored in the carrier part formed in this way, even in the face of high adhesive forces.

In a further preferred embodiment, it is provided that at least the stem parts are formed as hair-like individual needles and are applied to one side of the carrier part by means of flocking. In this way, fastening devices can be obtained in a cost-effective manner at high production speeds.

In a further preferred method for producing a fastening device, it is provided that a casting method, such as a chill roll method, is used. In this way, in particular, fastening devices with a high number of interlocking elements per cm² can be obtained in large quantities. Instead of the specified chill roll method, such fastening devices can also be obtained via an extrusion method.

If it is desired to give the interlocking elements on the carrier part a predeterminable orientation in order to predetermine the respectively required hook-and-loop fastener property, the use of a combing methods for the interlocking elements formed in a hair-like manner can preferably be provided.

Preferably, such fastening devices in conjunction with a further fastening device form a fastening system as a whole in the sense of a hook-and-loop part, in which the components of the hook-and-loop part, in this case in the form of the two fastening devices, can be connected to and detached from one another multiple times. Particularly preferably, such fastening systems can be used for fastening floor mats in vehicles.

### BRIEF DESCRIPTION OF THE DRAWINGS

In the following, a fastening device according to the invention is explained in more detail with reference to the drawing in a basic illustration that is not to scale. Here, the following is shown:

FIG. 1 a lateral illustration in sections of a fastening device according to the invention;

FIGS. 2a to 2e the embodiment according to FIG. 1 with differently arranged, in particular inclined, interlocking elements;

FIGS. 3 to 5 the fastening device according to FIG. 1 with differently formed carrier parts;

FIGS. 6 to 8 the fastening device according to FIG. 1 with different functional layers on the rear side of the carrier part; and

FIGS. 9 and 10 two different embodiments of a fastening system, in particular for fixing a floor mat to a floor assembly.

### DETAILED DESCRIPTION OF EMBODIMENTS OF THE INVENTION

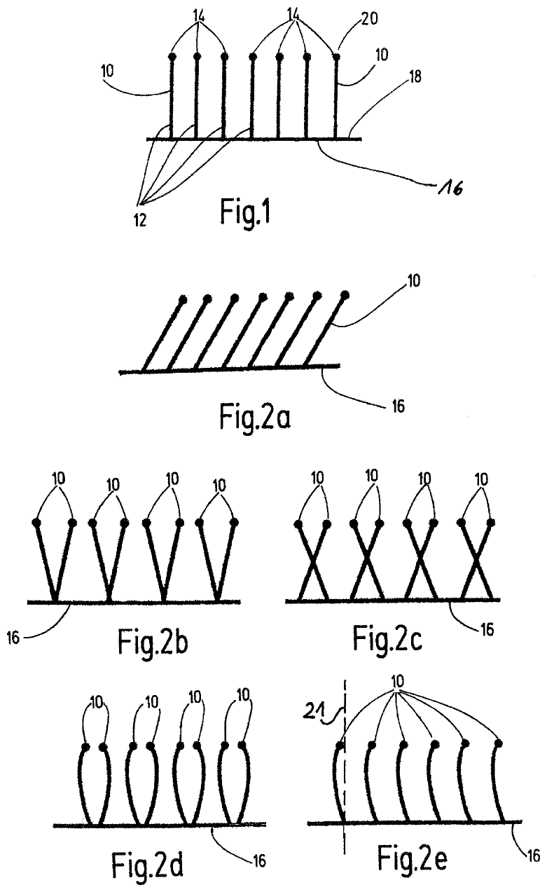

FIG. 1 shows a fastening device consisting of a plurality of spaced-apart interlocking elements 10 made of a plastics material, each of which projects towards one side from a carrier part 16 by being provided with a stem part 12 and a head part 14, in this case upwardly as viewed in the vertical direction. The fastening device is a three-dimensional body and the arrangement shown in FIG. 1 with the interlocking elements 10 continues transversely into the drawing plane, wherein, preferably, all adjacent interlocking elements 10 in the row and column arrangement have an equal distance from one another.

The number of interlocking elements 10 is 100 to 200 pieces per cm², preferably 120 pieces per cm². Furthermore, the diameter of an individual interlocking element is 150 to 250 μm, preferably 213 μm. The height of the respective interlocking element 10, calculated from the root-side base 18 on the carrier part 16 to the upper head-part end is 1200 to 2200 μm, preferably 1500 to 1980 μm. The dimension of the largest head-part diameter of an interlocking element 10 is 200 to 400 μm, preferably 220 to 290 μm. The head parts 14 shown in FIG. 1 and also the head parts 14 shown in the further figures are formed to be spherical, however, other head shapes are also conceivable here, for example in the form of flat or upwardly curved disks (not shown). Preferably, the interlocking elements 10 as well as the carrier part 16 are made of polyester or polyamide, such as PA66.

As can be further seen from the figures, the individual interlocking elements 10 all have the same height when viewed from the upper side or base 18 of the carrier part 16, and according to the illustration according to FIG. 1, the interlocking elements 10 extend upwards in the vertical direction when viewed from the carrier part 16.

In the illustration according to FIG. 2a, all interlocking elements 10 are inclined at an angle in one direction as viewed from the horizontally running carrier part 16, wherein all interlocking elements 10 have the same angle of inclination relative to the carrier part 16.

In the embodiment according to FIG. 2b as well as to FIG. 2c, the individual interlocking elements 10 are arranged in pairs assigned to one another in a V-shaped or X-shaped manner on the carrier part 16. In the embodiment according to FIG. 2d, the stem parts 12 of a pair of interlocking elements 10 are inclined towards one another in an arc shape, and in the illustration according to FIG. 2e, they are formed in a parallel arrangement as individual elements with a stem part profile 12 curved in an arc shape. As can be seen further from FIG. 2e, the arc-shaped curvature for the respective stem part 12 is selected such that a free head side of the head part 14, here right side as viewed in the direction of FIG. 2e, as viewed in perpendicular projection onto the carrier part 16, runs within an associated notional projection line 21 that ends at the root side at a transition point between the stem part 12 and the carrier part 16. For the different orientation of the interlocking elements 10, which are also referred to in technical language as pole elements, combing methods customary in the textile sector are used, so that this will not be discussed in any further detail.

In the embodiment according to FIG. 1, a so-called casting method in the form of a chill roll method is used for producing the fastening device to this effect, as shown by way of example in DE 196 46 318 A1. In this case, the interlocking elements 10 are produced by supplying a thermoplastic resin to a gap between a pressure roller and a forming roller. In this case, the forming roller has a screen with open cavities that have been manufactured by etching or by means of a laser, such that the finished interlocking elements 10 are formed solely by the fact that the thermoplastic resin hardens at least partially in the open cavities of the screen of the forming roller.

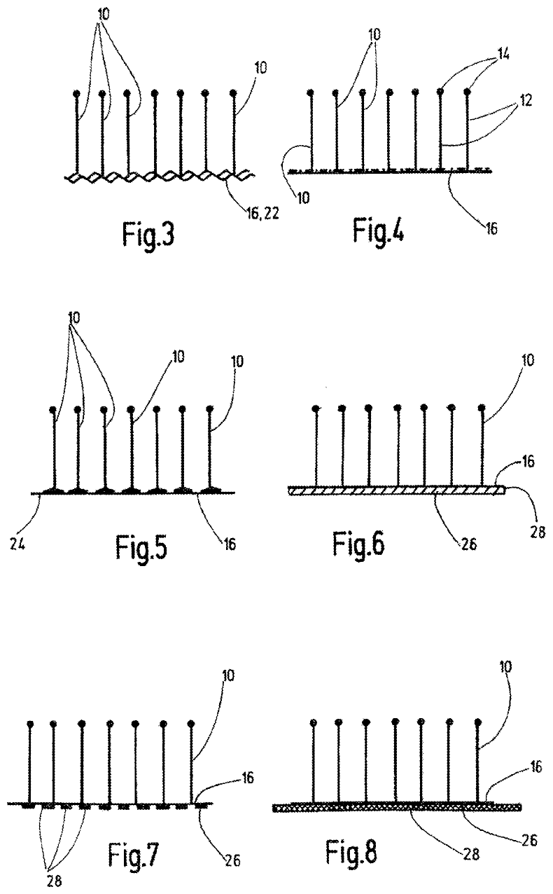

In the embodiment according to FIG. 3, in the scope of the associated production method, the loops of a loop pile fabric having a carrier part 16 are cut open to form stem parts 12, and the free loop ends are each scarfed to form the head part 14 of an interlocking element 10. A production method to this end for such a fastening device as a flat hook-and-loop part is shown in DE 102 40 986 B3. In this case, the fastening device has a base fabric 22 made of warp threads and weft threads, with a plurality of functional threads partially passing through the base fabric to form the interlocking elements 10. It can be provided that either the weft threads and/or the warp threads are formed to run in a wave-shaped or arc-shaped manner, such that a flat hook-and-loop part can be realized as a woven fastening device in a cost-effective production method, wherein the fastener has very high adhesive and peel strength values for the interlocking elements 10.

In the embodiment according to FIG. 4, a method and device for producing fastening devices are used for the fastening device therein, as shown in DE 10 2005 043 452 A1. Here, a strip-shaped carrier part 16 is provided and a high-voltage electric field is generated between a dispensing device for the stem parts 12 and the carrier part 16, along the field lines of which the stem parts 12 are transported in a predeterminable number from the dispensing device to the carrier part 16, wherein the carrier part 16 preferably forms such a consistency that the stem parts 12 may penetrate with their one end into the carrier part 16 and be fixed there. In this way, fastening devices can be obtained cost-effectively at high production speeds. If the stem parts 12 are applied without associated head parts 14, these must first be generated, for example, by thermal melting of the free stem part ends. In this respect, the fastening device according to FIG. 4 is thus produced by a type of flocking method, although other flocking methods not described in more detail may also be used.

A further option for producing the fastening device according to the invention is to form interlocking elements 10 in at least a partial region without a mold, by depositing the plastics material in successively delivered droplets by means of at least one applicator apparatus, and the locations of deposition of the droplets are selected three-dimensionally with respect to the shape of the respective hook-and-loop fastener element to be formed. Such a 3D printing method, with which the interlocking elements are individually printed onto the film-like carrier part 16 in the manner of a 3D film 24, is the subject matter of FIG. 5 and described in more detail in DE 101 06 705 C1.

Another production method is shown in DE 100 58 890 C1, regarding a so-called extrusion method. In this case, two shaping strands are used for the continuous production of a fastening device, each consisting of individual shaping parts, assigned to one another in groups over a predeterminable shaping section and provided with a shaping material, and held against one another in such a way that, after separation of the groups of shaping parts, the hook-and-loop part or the fastening device is obtained.

According to the illustration according to FIG. 6, a functional part 28 may be applied to the side 26 of the carrier part 10 that is rearward of the interlocking elements 10. In the embodiment according to FIGS. 6 and 7, the functional part 28 is a self-adhesive layer or a reactivatable layer provided for an adhesive connection. The self-adhesive layer as the functional part 28 can be formed of a rubber or acrylic adhesive. The reactive functional layer, on the other hand, forms a connection with non-specified third-party components only under thermal influence, wherein the functional layer to this effect can also be welded. In the solution according to FIG. 8, a profile or clip part is attached to the rear side 26 of the carrier part 16 as a functional part 28 on the fastening device shown there, for example by means of an adhesive connection, wherein the design of the functional part 28 to this effect can basically be freely predetermined and adjusted to the respective application requirements.

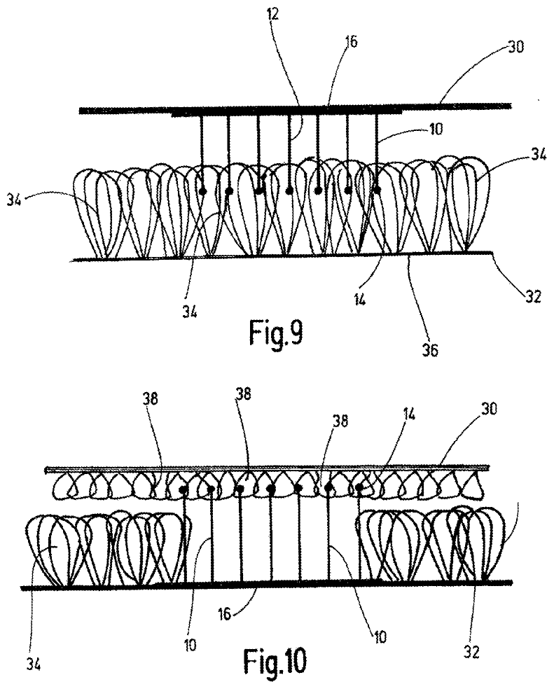

There is a wide range of possible applications for the fastening device according to the invention. In a preferred embodiment, however, it is provided that the fastening device according to the illustration according to FIG. 9 is glued or otherwise fastened to a conventional floor mat 30 and that the floor mat 30 thus equipped according to the illustration according to FIG. 9 is laid on a so-called floor assembly textile 32. In doing so, the fastening device of the floor mat 30 comes into interlocking engagement with the loops 34 of the floor assembly textile 32. For reliable fastening of the doormat 30, a plurality of fastening devices may be provided on the floor mat 30, for example in the corner regions of a related floor mat 30. The loops 34 or the floor assembly textile 32 as a whole are part of a vehicle floor 36, not shown in greater detail, in the footwell of a conventional motor vehicle. Due to the hair-like protrusions formed by the stem parts 12 of the fastening device, which carry the head parts 14 at their ends with an outer circumference that is only slightly larger than the diameter of the associated stem part 12, it is surprising that a fastening system is created in a re-detachable manner with the loop pile fabric 34 of the floor assembly textile 32, with which extremely high shear resistances may be generated. The small head parts 14 further ensure that when the fastening system is reopened, in which the two fastening devices are once in connection with the floor mat 30 and once in connection with the loops 34 or snares of the floor assembly textile 32, the pertinent loop fabric or loop pile fabric is not unnecessarily roughened or even destroyed. In particular, when viewed in the direction of FIG. 9, in the vertical orientation of the two fastening devices which are in engagement with one another, a fastening system as a whole which is axially very small is achieved.

In the embodiment according to FIG. 10, this is changed compared to the embodiment according to FIG. 9 insofar as the fastening device according to the invention is now part of the floor assembly textile 32 and the floor mat 30 has a loop pile material 38 on its front side facing the one fastening device, which interacts with the interlocking elements 10 of the floor assembly textile 32 with its loops 34. Here, too, it is advantageous if, for a secure anchoring of the floor mat 30 to the floor assembly in the footwell of a vehicle, a plurality of fastening devices according to the invention are distributed for an interlocking process. In both solutions according to FIGS. 9 and 10, the floor mat 30 can be easily detached from the floor in the footwell. With optimized adhesive force, the floor mat 30 can nevertheless be easily detached from the floor in the footwell, which facilitates the cleaning of the floor assembly textile 32, for example using a car vacuum cleaner. Furthermore, the floor mat 30 can be fixed inside the vehicle in a flexible manner, which simplifies handling.

What is claimed is:

1. A fastening device, consisting of:
a plurality of individual spaced-apart interlocking elements made of a plastics material, each of which projects towards one side from a carrier part by being provided with a stem part and a head part;
wherein the number of interlocking elements is 100 to 200 pieces per cm²;
wherein the respective diameter of the stem part of an interlocking element is 150 to 250 μm;
wherein the height of the respective interlocking element, calculated from the root-side base on the carrier part to the head-part end, is 1200 to 2200 μm; and
wherein the dimension of the largest head-part diameter of an interlocking element is 200 to 400 μm.

2. The fastening device according to claim 1, wherein the interlocking elements all have the same height as viewed from the carrier part and extend away from said carrier part in a vertical or obliquely inclined manner, and/or in that pairs of interlocking elements arranged adjacent to one another on the carrier part form a V-shape or X-shape with one another, and/or in that the stem parts are curved in an arc shape with the same or different orientation.

3. The fastening device according to claim 1, wherein the arc-shaped curvature of a stem part is selected that a free head side of the head part, as viewed in perpendicular projection onto the carrier part, runs within an associated projection line that ends at the root side at a transition point between the stem part and the carrier part.

4. The fastening device according to claim 3, wherein the respective curvature is more curved as viewed in the direction of the head part than in the direction of the root-side end of the stem part.

5. The fastening device according to claim 1, wherein the interlocking elements with their curved stem parts are inclined towards one another in pairs with their head parts, forming a kind of clamp-like receiving opening.

6. The fastening device according to claim 1, wherein the carrier part consists of a woven fabric, a warp-knit fabric or a weft-knit fabric with interlocking elements interwoven therein or of a 3D film.

7. The fastening device according to claim 1, wherein a functional part is applied to the side of the carrier part that is rearward of the interlocking elements in the form of a self-adhesive layer or a reactivatable layer or in the form of an additional fastening part, such as a plastic profile or a plastic clip.

8. The fastening device according to claim 1, wherein the interlocking elements and/or the carrier part are made of polyester or polyamide, such as PA66, as plastics materials.

9. A method for producing the fastening device according to claim 1, wherein:
the loops of a loop pile fabric having the carrier part are cut open to form the stem parts, and free loop ends are each scarfed to form the head part of the interlocking element;
at least the stem parts formed as hair-like individual needles are applied by means of flocking onto one side of the carrier part;
a casting method, being a chill roll method, is used; or
a combing method is used for a different orientation of the interlocking elements.

10. The fastening device according to claim 1, including a fastening system having the fastening device produced wherein the loops of a loop pile fabric having the carrier part are cut open to form the stem parts, and free loop ends are each scarfed to form the head part of the interlocking element, wherein a further fastening device is present that, formed as a loop material, forms a re-detachable connection with the one fastening device while realizing a fastening in vehicles.

11. The fastening device according to claim 1, including a fastening system having the fastening device produced wherein at least the stem parts formed as hair-like individual needles are applied by means of flocking onto one side of the carrier part, wherein a further fastening device is present that, formed as a loop material, forms a re-detachable connection with the one fastening device while realizing a fastening in vehicles.

12. The fastening device according to claim 1, including a fastening system having the fastening device produced wherein a casting method, being a chill roll method, is used, wherein a further fastening device is present that, formed as a loop material, forms a re-detachable connection with the one fastening device while realizing a fastening in vehicles.

13. The fastening device according to claim 1, including a fastening system having the fastening device produced wherein a combing method is used for a different orientation of the interlocking elements, wherein a further fastening device is present that, formed as a loop material, forms a re-detachable connection with the one fastening device while realizing a fastening in vehicles.

14. The fastening device according to claim 1, wherein the number of interlocking elements is 120 pieces per cm².

15. The fastening device according to claim 1, wherein the respective diameter of the stem part of an interlocking element is 213 μm.

16. The fastening device according to claim 1, wherein the height of the respective interlocking element, calculated from the root-side base on the carrier part to the head-part end, is 1500 to 1980 μm.

17. The fastening device according to claim 1, wherein the dimension of the largest head-part diameter of an interlocking element is 220 to 290 μm.
